(19) United States
(12) Patent Application Publication
(10) Pub. No.: US 2003/0217072 A1
(43) Pub. Date: Nov. 20, 2003

(54) Information retrieval method and information registration method

(76) Inventor: Kazuhiro Tsumura, Yokohama-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/458,221

(22) Filed: Jun. 11, 2003

Related U.S. Application Data
(63) Continuation of application No. PCT/JP00/08738, filed on Dec. 11, 2000.

(51) Int. Cl. G06F 17/00

(52) U.S. Cl. 707/102

(57) ABSTRACT

Retrieval information is input from a terminal device to the server of a broadcasting station via the Internet. The broadcasting station's server converts the retrieval information into text information and broadcasts it. The broadcasted text information is received by a terminal device equipped with a teletext broadcasting receiving function. Then, the requested information is searched for out of pre-registered provided information, and thus searched information is transmitted via the Internet to the terminal device that made the request.

### CROSS-REFERENCE TO RELATED APPLICATIONS

This is a Continuation Application of PCT Application No. PCT/JP00/08738, filed Dec. 11, 2000, which was not published under PCT Article 21 (2) in English.

### BACKGROUND OF THE INVENTION

1. Field of the Invention

The present invention relates to an improvement of the information retrieval method of searching for necessary information through the Internet. Further, the present invention relates to an information is registration method for registering information to be searched for by the information retrieval method.

2. Description of the Related Art

As conventionally known, according to prior art, when necessary information is to be searched and obtained with use of the Internet, first, the user has to access a search service site and carries out a keyword search. The user, then, access a certain site on the basis of the result of the search.

However, with such a conventional information retrieval method, search is carried out on the data that have been collected by the search service site in advance. Therefore, how suitable searched data is for a request made by the user entirely depends on the quality of the search service site.

It is difficult for an ordinary user to collect information by utilizing all the search service sites that presently exist. Therefore, conventionally, there are many cases where the information that suits the request of the user cannot be obtained due to search omission even though the appropriate information does exist.

The present invention has been achieved in consideration of the above-described circumstances, and an object thereof is to provide an information retrieval method that can search more various information in addition to conventional search service by supplying information registered in personal computers and mobile terminals (to be called terminal devices) of individual users to a search service.

Another object of the present invention is to provide an information registration method that can register information to be searched by means of the information retrieval method, to a personal computer, mobile terminal or the like of an individual user by himself or herself.

### BRIEF SUMMARY OF THE INVENTION

According to the present invention, there is provided an information retrieval method comprising: a first step of receiving retrieval information for retrieving information requested by a terminal device via the Internet; a second step of converting the retrieval information into text information and broadcasting it; and a third step of making a terminal device equipped with a teletext broadcasting receiving function for receiving broadcasted text information, search information requested by the text information out of provided information registered in advance, and transmit the searched information to the terminal device requesting the search via the Internet.

With the above-described method, information registered not only in a particular search service site but also in a personal computer, mobile terminal or the like of an individual user, can be provided to search service. Therefore, it is possible to search out of more various information pieces in addition to those of the conventional search service.

According to the present invention, there is further provided an information registration method comprising: a first step of accessing a broadcasting station server by a terminal device via the Internet, and downloading application software used to register provided information; and a second step of inputting information provided from the terminal device and registering the information at a predetermined memory site based on an instruction made by the application software downloaded in the first step.

With the above-described method, information provided as an object of search can be easily registered in a personal computer, mobile terminal or the like of an individual user by himself or herself, and therefore necessary information can be obtained in almost real time.

### BRIEF DESCRIPTION OF THE SEVERAL VIEWS OF THE DRAWING

FIG. 1 is a diagram showing an embodiment of the information retrieval method and information registration method according to the present invention, which is designed to illustrate the information retrieval system briefly;

FIG. 2 is a flowchart illustrating data retrieval operation in the above embodiment;

FIGS. 3A to 3C are diagrams each illustrating a display image at a respective stage of the data retrieval operation in the embodiment;

FIGS. 4A and 4B are diagrams each illustrating a display image at a respective stage of a data registration operation in the embodiment; and

FIG. 5 is a diagram showing each of the operations and processes carried out among an information retrieval side, a broadcasting station server and an information provider side.

### DETAILED DESCRIPTION OF THE INVENTION

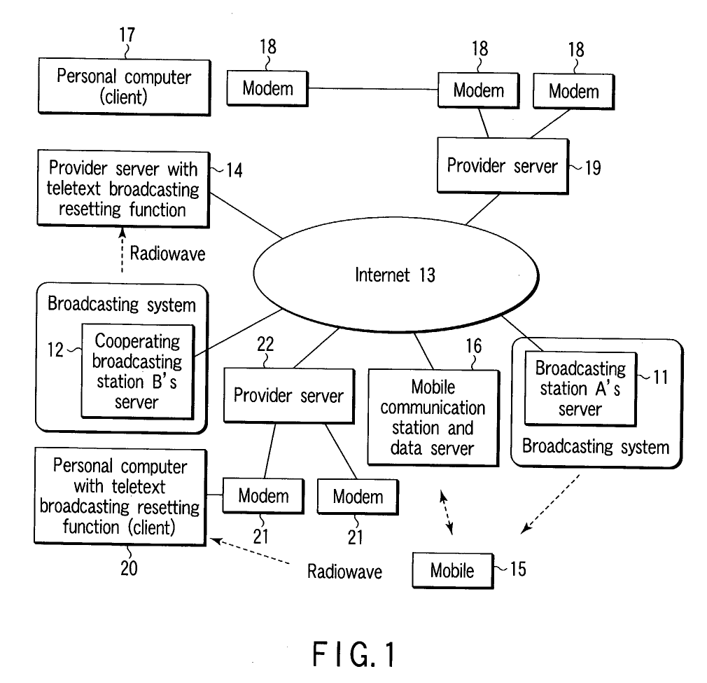

An embodiment of the present invention will now be described in detail with reference to accompanying drawings. FIG. 1 is a diagram showing a brief structure of the information retrieval system described in connection with this embodiment.

In this information retrieval system, for example, a broadcasting system equipped with a broadcasting station A's server 11 and a broadcasting system equipped with a cooperating broadcasting station B's server 12 in cooperation with the broadcasting station A's server 11 are connected to each other via the Internet 13.

To the Internet 13, a provider server 14 equipped with a teletext broadcasting receiving function for receiving broadcasting radio waves from the broadcasting station A and the cooperating broadcasting station B, and a data server 16 of a mobile communication station capable of radio communications are connected. Further, a mobile terminal 15 for receiving teletext broadcasting in the form of radio wave from the broadcasting station A and the mobile communication station.

Furthermore, to the Internet 13, a personal computer 17 of an individual user, which is a terminal device, is connected via a modem 18 and the provider server 19.

Furthermore, to Internet 13, a personal computer 20 of an individual user, equipped with a teletext broadcasting receiving function, which is a terminal device that receives broadcasting radio wave from the broadcasting station A and the cooperating broadcasting station B, is connected via a modem 21 and a provider server 22.

In the information retrieval system having the above-described structure, for example, a user accesses a home page “search service” of the broadcasting station A's server 11 using the personal computer 17 of himself or herself, and inputs retrieval information (, for example, search keyword or request of what sort of information is needed) in the form of sentence(s).

At the same time, the user inputs, as retrieval information, the return mail address to which retrieved information should be mailed, user ID, etc. Then, the broadcasting station A's server 11 transfers the accepted retrieval information to the cooperating broadcasting station B, and the server 11 outputs the broadcasting time of the search message to the personal computer 17 as a reception result for the user.

When it is the broadcasting time for the searched message, the server 11 of the broadcasting station A and the server 12 the cooperating broadcasting station B broadcast the accepted search information (search keyword, return mail address, etc.) in the form of text information.

On the other hand, the provider server 14 equipped with the above-described text broadcasting receiving function, and terminal devices such as the mobile terminal 15 and personal computer 20 have providable information that was registered in advance in the Web data base in the case of the provider server 14, or in the mobile terminal 15 and personal computer 20 themselves.

Then, the provider server 14, mobile terminal 15, personal computer 20, etc. search data corresponding to the requested contents out of the providable information that have been registered, on the basis of the received text information. When the data is found, they send the data to the return mail address, and thus the information search is completed.

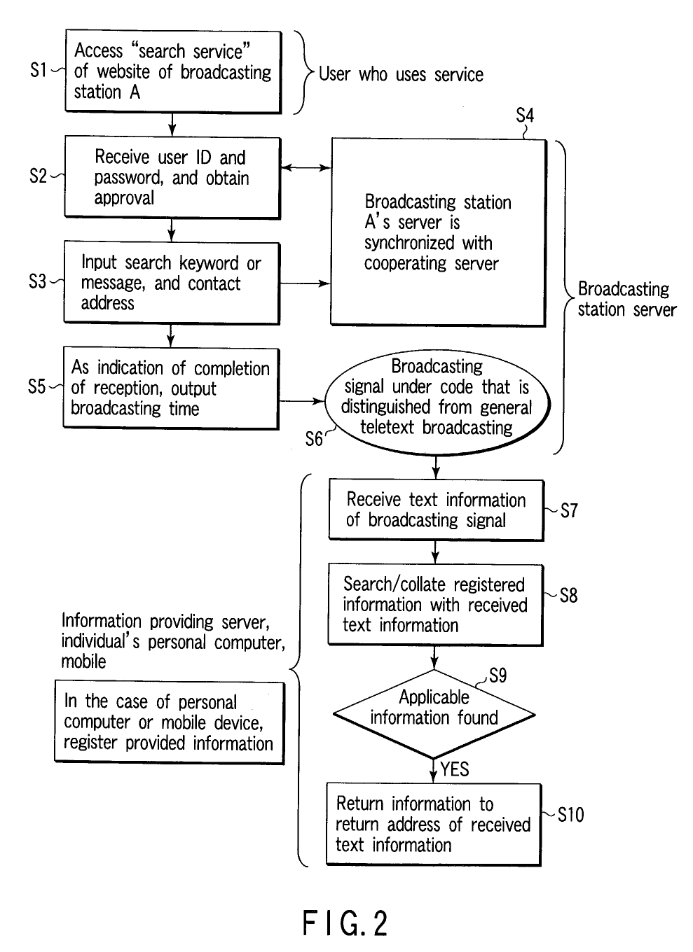

FIG. 2 is a flowchart that summarizes a series of operations carried out in the above-described information search. First, a user who would like to use the search service accesses the home page (web site) “search service” of the broadcasting station A's server 11 with the personal computer 17 of himself or herself in step S1.

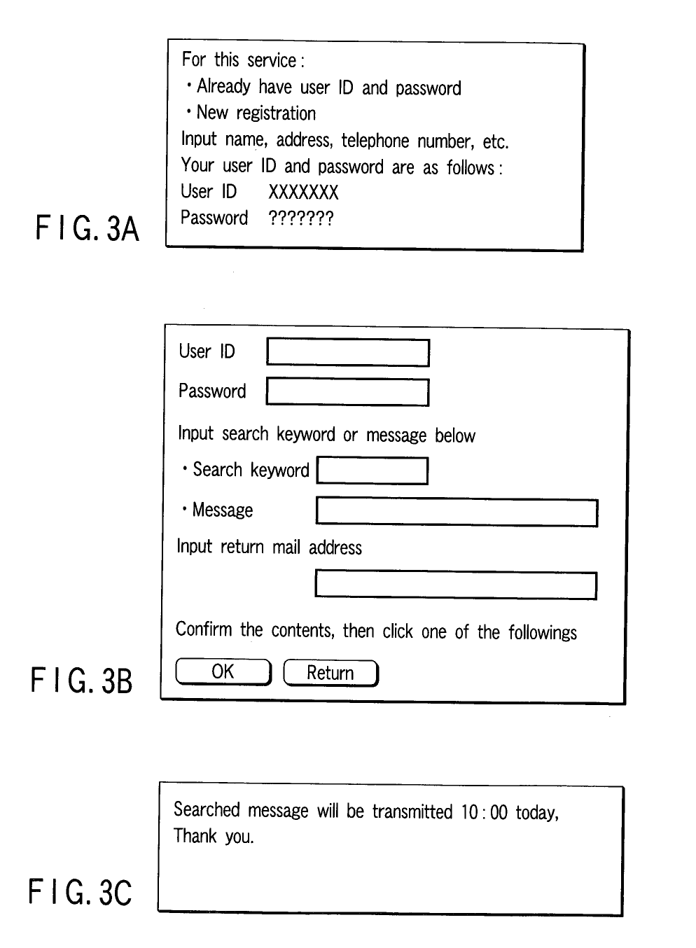

Then, the user, in step S2, receives a user ID and a password issued by the broadcasting station A's server 11 when he or she is approved by the server. In order to obtain the approval, the user has to reply to the inquiries made by the broadcasting station A's server 11 in the form of display as shown in FIG. 3A.

More specifically, the broadcasting station A's server 11 inquires the followings of accessing users. That is, the server asks if the user has the user ID and password for obtaining the “search service”, or if the user is new and would like to register himself or herself to the server. In the case of new registration, the user is required to input the name, address, telephone number, etc. and when they are input, the user ID and password are issued by the server.

When the approval procedure for obtaining a “search service” is completed as described above, the user, in step S3, inputs a search keyword or message, and the return mail address (user's contact address), etc. These data can be input by the user as he or she replies to the inquiries of the display displayed by the broadcasting station A's server 11 as shown in FIG. 3B.

That is, the broadcasting station A's server 11 asks the user to input the user ID and password, and when they are input, the server then asks the user to input a search keyword or message as search information, and the return mail address. When these data are input, the server asks the user to select “OK” (confirmation of input data) or “Return” to previous page.

It should be noted that during the process of these steps S2 and S3, the broadcasting station A's server 11 operates in synchronism with the cooperating broadcasting station B's server 12 as shown in step S4, and thus all the data input by the user is automatically transferred to the cooperating broadcasting station B's server 12.

When the user selects “OK”, the broadcasting station A's server 11 judges that the reception is completed in step S5, and then displays an image such as shown in FIG. 3C, in order to present the broadcasting time of the search message.

In the meantime, the broadcasting station A's server 11 converts the search information inputted by the user before in step S6, into the form of text information. When the broadcasting time comes, the text information is broadcasted as the search message by teletext broadcasting.

In this case, the search information is converted into a broadcasting signal under a code that is distinguished from text information used in ordinary teletext broadcasting, that is, text information in the form that is not displayed on the screen of a teletext broadcasting receiving device.

On the other hand, the teletext broadcasting receiving devices (terminal devices) such as the provider server 14 having the above-described teletext broadcasting receiving function, mobile terminal 15, personal computer 20, etc., receive text information in the teletext broadcasting signal in step S7.

After that, in step S8, these teletext broadcasting receiving devices search for information requested by the received text information out of the providable information that has been registered and set in advance in the database at a certain site or the memory of a personal device.

Then, in the case where data that matches the requested information is found in the registered information in step S9, each teletext broadcasting receiving device returns the searched information to the return mail address contained in the received text information in step S10. Thus, the information search is completed.

Next, the method of registering providable data in each of the teletext broadcasting receiver devices such as the information a the provider server 14 equipped with the teletext broadcasting receiving function, mobile terminal 15, personal computer 20, will now be described.

In the basic sense, in order for a user to search for necessary information from providable information registered in advance, the collating function between character strings in natural language should be utilized; however at the present technology level, it is difficult to obtain a sufficient accuracy.

Under the circumstances, in this embodiment, this embodiment employs a method of registering information by a designated format in order to improve the information collating accuracy even at the present technology level.

First, the user of each teletext broadcasting receiving device access the home page (web site) of the broadcasting station A's server 11, and downloads the application software used to register provided information to the device of the user.

In this manner, it is possible to unify the format of the search information inputted by opening the “search service” of the home page (web site) of the broadcasting station A's server 11 by the information requesting side, and the formation of the providable information registered by the information providing side. Thus, the collation accuracy can be improved.

The following are explanations of an example of the operation for inputting information to be registered by the user of a teletext broadcasting receiving device with use of the application software that has been downloaded to the device of himself or herself.

Here, in order to express information to be provided in detail, identification tags such as adverb/adjective, time and place are necessary. Therefore, in the application software that will now be explained in connection with this embodiment, the identification tag for information to be registered is changed from one type of information provided to another.

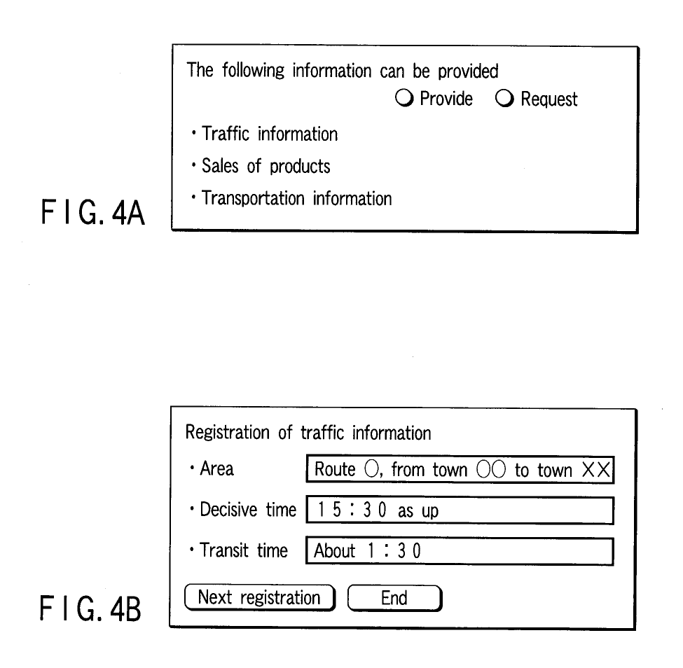

More specifically, according to the application software, an image such as shown in FIG. 4A is displayed, by which the user is instructed to select the type of information and whether information is provided or required.

For example, if the “traffic information” is selected as the type of information and the “provision” is selected, the image is shifted to one as shown in FIG. 4B, and the user is instructed to input the area, decisive time, transit time, and the like. These input information items can be further divided into details with use of identification tags of detailed information. As the information items are further classified in more detail, the collation accuracy is increased.

For example, in order for the user who would like to register information to register the time that is actually required to pass an area (transit time), it is important to input, in addition to the transit time, data such as the area/place and time. These information items are classified with use of identification tags, and the specific text data are input to an input region (text box).

It is only natural here that when these identification tags are used as well for the items to be input to the home page (web site) of the broadcasting station A's server 11, it is possible to be matched with the requesting side.

When the input of the information to be registered is completed as described above, the user is instructed to select if there is a next information item to be registered or the registration is finished. For wither one of the selections, the confirmation message for the input information is displayed and then the actual registration process is carried out. The term “registration” used here is meant to be registration of text information received from the broadcasting station A's server 11 to a search device (memory site).

In the case where the next registration is selected, the image returns to the one shown in FIG. 4A, and the device stands by for the next registration. If the finish of registration is selected, the registration process is finished, and the device is set to be standby for another search request in text information from the broadcasting station A's server 11.

In addition to the above, as a means for registering providable information, a personal schedule note application (mobile terminal) can be utilized. For example, if a schedule of “a party on month M1 day D1” is set, the search-collation application collates received text information such as “party venue” and “preservation available date: day D1, day D2, . . . ” with the data in the schedule. Then, when the information match, the device notifies the user by means of buzzer or the like that matching data has come in.

With regard to such a schedule application, it is best to download the information from the home page (web site) of the broadcasting station in order to improve the collation accuracy; however it is not necessary to limit the invention to this method.

Here, the information provider side, that is, the user of each teletext broadcasting receiving device registers in advance himself or herself as an information provider to the broadcasting station A's server 11 when downloading the application software used to register information to be provided, to the device of himself or herself. Thus, each time the user provides information, or a contract is made, he or she can receive a predetermined reward.

The side that requests the information search service, for example, as in the case of publishing an advertisement, pays a certain reward per case or a certain percentage of the contract amount.

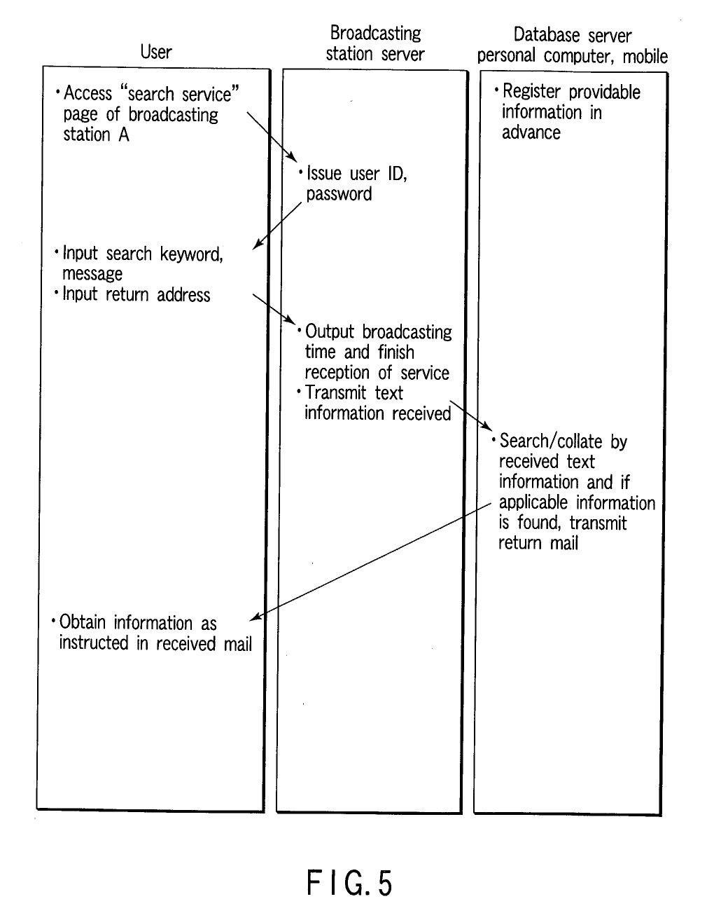

FIG. 5 is an organized chart summarizing the operations and processes conducted on each side of the user who requests information search, the broadcasting station A's server that has the home page (web site) of the search service and the information provider.

According to the embodiment described above, not only information that has been registered in a particular search service site but also information that is registered via a person computer, mobile terminal or the like of a user are made available for use in the search service. Therefore, as compared to the conventional search service, search can be conducted on more abundance of information.

Further, according to the embodiment, information that can be an object of search can be easily registered by means of a personal computer, mobile terminal or the like of the user himself or herself. Therefore, necessary information can be obtained in almost real time.

Furthermore, search information input by a user who requests search of information is converted into text information in the mode that is not displayed on the screen of a teletext broadcasting receiving device on the information provider side, and broadcasted. In this manner, the concealment is maintained between the information requesting side and the information provider side.

Furthermore, in terms of business, since a search message is broadcasted as text information, the present invention is suitable for a service that is conducted by a television broadcasting station.

Furthermore, the present invention can be realized as a product of software for collating text information, software for managing registered information, and the like, that can be operated on a terminal device of a user, such as a person computer or mobile terminal.

As described in detail above, according to the present invention, there is provided an information retrieval method that makes it possible to search information from a more abundance of information that that of the conventional search service by making information registered by individual users via a terminal device such as a personal computer or mobile terminal available to the search service.

Further, according to the present invention, there is provided an information registration method that makes it possible for an individual user to easily register information to be searched for by the above-described information retrieval method via a terminal device such as a personal computer or mobile terminal.

What is claimed is:

1. An information retrieval method comprising:
a first step of receiving retrieval information for retrieving information requested by a terminal device via the Internet;
a second step of converting the retrieval information into text information and broadcasting it; and
a third step of making a terminal device equipped with a teletext broadcasting receiving function for receiving broadcasted text information, search information requested by the text information out of provided information registered in advance, and transmit the searched information to the terminal device requesting the search via the Internet.

2. The information retrieval method according to claim 1, wherein the first step includes a step of including a return mail address in the retrieval information; and
the third step includes a step of transmitting the searched information to the terminal device by which the search is requested, on the basis of the return mail address contained in the received text information.

3. The information retrieval method according to claim 1, wherein the first step includes:
a step of making a user input the retrieval information on the basis of instructions provided on an image displayed on the terminal device; and
a step of displaying a time when the retrieval information is broadcasted as text information on the terminal device after the input of the retrieval information is finished.

4. The information retrieval method according to claim 1, wherein the first step includes a step of including information for identifying a user in the retrieval information input from the terminal device.

5. The information retrieval method according to claim 1, wherein the second step includes a step of converting the retrieval information input from the terminal device into text information of a format that is not displayed on the terminal device equipped with the teletext broadcasting receiving function.

6. The information retrieval method according to claim 1, wherein the terminal device equipped with the teletext broadcasting receiving function includes at least one of a provider server, a personal computer and a mobile terminal.

7. An information registration method comprising:
a first step of accessing a broadcasting station server by a terminal device via the Internet, and downloading application software used to register information to be provided; and
a second step of inputting information to be provided from the terminal device and registering the information at a predetermined memory site based on an instruction made by the application software downloaded in the first step.

8. The information registration method according to claim 7, wherein the second step includes a step of inputting the information to be provided in accordance with instructions provided on an image displayed on the terminal device based on the application software.

9. The information registration method according to claim 7, wherein the second step includes a step of hierarchically subdividing the information to be provided such as to be inputted, and registering thus subdivided information items after assigning identification tags to the information items.
